(19) United States
(12) Patent Application Publication
(10) Pub. No.: US 2007/0178895 A1
(43) Pub. Date: Aug. 2, 2007

(54) Method, network entity, system, mobile device and computer program product for automatic provisioning of a service

(75) Inventor: Menno Bot, Makati City (PH)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/344,658

(22) Filed: Jan. 31, 2006

(51) Int. Cl. H04Q 7/20

(52) U.S. Cl. 455/432.1

(57) ABSTRACT

A method, system, network entity and computer program product are provided for automatically provisioning a service in the instance where a need for provisioning of the service arises. In particular, a provisioning system is configured to automatically provision a service for a mobile device as a result of there being a current desire or need to establish a session of the service with the mobile device. In one exemplary embodiment, this includes provisioning a messaging service for a mobile device as a result of the mobile device becoming the intended recipient of a message that requires such service provisioning. Provisioning the service may involve arranging for various settings needed to implement the service to be transmitted to the mobile device, as well as updating the mobile device's subscription information to include the subscriptions needed for the particular messaging service.

### FIELD OF INVENTION

Exemplary embodiments of the present invention relate generally to service provisioning and, in particular, to automatic service provisioning in the instance when a need for such service provisioning arises.

### BACKGROUND OF THE INVENTION

Multimedia Messaging System or Service (MMS) is a service that enables the transmission of text messages, as well as graphics, video clips, sound files, and other kinds of multimedia content over a wireless network. MMS is designed to work with mobile package data services such as General Packet Radio Service (GPRS) and other third generation (3G) wireless networking protocols.

In general, the process begins where an MMS client transmits an MMS message to an MMS Center (MMSC). The message may include, for example, a picture of St. Peter's Basilica to be downloaded to the intended recipient's cellular telephone, or other wireless communication device, such as a personal digital assistant (PDA), laptop or pager, along with a voice message saying “This is what I saw in Italy.” The MMS client may comprise an individual possessing an MMS subscription (i.e., a person-to-person MMS transmission). Alternatively, the MMS client may comprise an MMS application from which the recipient has requested transmission of an MMS message. One example of the latter would be where an individual sees an advertisement, such as one displayed on the bottom of the television screen during a World Wrestling Federation (WWF) wrestling match, that instructs the individual to send, for example, a Short Message Service (SMS) text message to a particular number in order to receive some MMS content, such as a picture of a particular WWF wrestler participating in the match.

In response to receiving the MMS message, the MMSC will send a notification to the recipient's wireless communication device informing the recipient that he or she has received an MMS message. The notification may, for example, be in the form of an SMS message. Delivery of the MMS message to the recipient's communication device may be either immediate or deferred. Immediate delivery results in the MMS recipient receiving the MMS message immediately following the notification, without any user intervention or knowledge. By contrast, deferred delivery allows the recipient to choose whether or not he or she desires to receive the MMS message.

The foregoing, however, is based on the assumption that four conditions have been met. First, the network operator serving the intended recipient has infrastructure to support GPRS/3G and MMS, or similar service. Second, the intended recipient's wireless communication device has the capabilities necessary to receive an MMS, or similar, message. Third, that the intended recipient has a subscription for the data bearer in the Home Location Register (HLR) (i.e., the recipient must be registered for the ordinary high speed data service provided by the network operator), as well as for the MMS, or similar service. Finally, that the intended recipient's wireless communication device is configured correctly to connect to the network infrastructure for both the data bearer and the MMS, or similar service (e.g., the device has the necessary settings, such as the Access Point Name (APN) and Internet Protocol (IP) addresses needed to connect to the network infrastructure).

While the first two conditions can be assumed to be met in many cases, a large number of MMS messages transmitted fail to make it to their intended recipient because at least one of the these last two conditions has not been met.

One way to fulfill the third condition (i.e., that the recipient have the necessary subscriptions) is to force the individual to manually request the subscription by, for example, visiting the operator's office, calling their helpdesk or creating a self-service request through channels such as SMS or the Internet. A disadvantage to this method is that it requires the individual to initiate the transaction. Alternatively, the operator could give all of its subscribers such services by, for example, performing a mass provisioning. In other words, the operator could provide the data bearer and MMS, or similar service, subscriptions to all of its customers automatically. A disadvantage to this method, however, is that the operator may need to provide more capacity to accommodate all of these potential subscribers whilst it is not known whether or not they will in fact use the service. This may require investments in hardware, network bandwidth and/or product licenses, thus increasing costs to the operator.

Similar methods exist for fulfilling the fourth condition, with virtually the same drawbacks. In particular, each individual may be forced to manually request the requisite settings, or the operator may send the settings to all subscribers using automatic device detection. In other words, when a new customer first turns on his or her wireless communication device, an automatic device detection system, will detect that the device has been turned on and that the service has not been provisioned and will automatically provide the device with the needed settings.

These conditions and drawbacks are not limited to MMS messaging. By contrast the foregoing conditions and drawbacks may similarly apply to other types of messaging or similar non-connection-oriented services that likewise require that the intended recipient have certain subscriptions and/or settings in order to participate in a session of that service (e.g., email, instant messaging and/or download services). This may include, for example, where the individual is the intended recipient of a video call or video instant message, requiring the provisioning of a video call service.

A need, therefore, exists for an improved means of fulfilling these conditions, particularly in the instance where there is a current need or desire to establish a session of a particular service with an individual, such as where the individual is currently the intended recipient of an MMS, or other similar, message.

### BRIEF SUMMARY OF THE INVENTION

In general, exemplary embodiments of the present invention provide an improvement over the known prior art by, among other things, providing a means for automatically provisioning a service in the instance where a need for that service arises. In particular, exemplary embodiments of the present invention provide a means for automatically providing an individual with the subscriptions and settings necessary to establish a session of a particular service only where there is a current need or desire to establish that session. This may include, for example, providing the requisite settings and/or subscriptions for the receipt of an MMS, or other similar, message in the event that the individual becomes the intended recipient of such a message.

According to one aspect of the present invention, a method of automatically provisioning a service is provided. In one exemplary embodiment, the method includes: (1) receiving a request for authorization to establish a session of a service with a mobile device, wherein establishment of the session with the mobile device requires service provisioning; and (2) automatically provisioning the service for the mobile device in response to receipt of the request.

In one exemplary embodiment, provisioning the service includes arranging for one or more settings necessary for implementing the service to be transmitted to the mobile device. In another exemplary embodiment, provisioning the service includes updating subscription information associated with the mobile device to include one or more subscriptions necessary for the service. The subscription information may be maintained in a register associated with an operator responsible for providing one or more services to the mobile device.

According to one exemplary embodiment, the method further includes determining whether the service was previously provisioned to the mobile device. In this exemplary embodiment, the step of automatically provisioning the service is only performed upon a determination that the service was not previously provisioned. In yet another exemplary embodiment, the method further includes determining whether the mobile device is capable of supporting the service. In this exemplary embodiment, the step of automatically provisioning the service is only performed upon a determination that the mobile device is capable of the supporting the service.

In one exemplary embodiment, establishing a session of a service with the mobile device comprises transmitting a message to the mobile device. In this exemplary embodiment, the service may comprise Multimedia Messaging Service (MMS) and the message may comprise an MMS message.

According to another aspect of the present invention, a network entity capable of automatically provisioning a service is provided, wherein the network entity comprises a processor and a memory in communication with the processor. In one exemplary embodiment, the memory stores an application executable by the processor, wherein the application is capable, upon execution, of: (1) receiving a request for authorization to establish a session of a service with a mobile device, wherein establishment of the service with the mobile device requires service provisioning; and (2) automatically provisioning the service for the mobile device in response to receipt of the request.

According to yet another aspect of the present invention, a system for automatically provisioning a service is provided. In one exemplary embodiment, the system includes a mobile device, a service center and a network entity. The service center of one exemplary embodiment is configured to receive a request to establish a session of a service with the mobile device, and, in response, to transmit a request for authorization to establish the session of the service with the mobile device, wherein establishment of the session with the mobile device requires service provisioning. The network entity of one exemplary embodiment is, in turn, configured to receive the request and to automatically provision the service for the mobile device in response to receipt of the request.

In one exemplary embodiment, provisioning the service includes arranging for one or more settings necessary for implementing the service to be transmitted to the mobile device. The system of this exemplary embodiment may further include an Over-the-Air (OTA) Terminal provisioning system in communication with the network entity. In this exemplary embodiment, arranging for one or more settings necessary for implementing the service to be transmitted to the mobile device includes transmitting a request to the OTA Terminal provisioning system requesting that the settings be transmitted.

In another exemplary embodiment, provisioning the service includes updating subscription information associated with the mobile device to include one or more subscriptions necessary for the service. The system of this exemplary embodiment may further include a register associated with a network operator responsible for providing one or more services for the mobile device. In this exemplary embodiment, updating subscription information comprises updating subscription information maintained in the register.

In yet another exemplary embodiment, the network entity is further configured to transmit to the service center an authorization to establish the session with the mobile device following provisioning of the service. The service center of this exemplary embodiment may further be configured to receive the authorization and, in response, to establish the session with the mobile device.

According to another aspect of the present invention, a computer program product for automatically provisioning a service is provided. The computer program product contains at least one computer-readable storage medium having computer-readable program code portions stored therein. The computer-readable program code portions of one exemplary embodiment include: (1) a first executable portion for receiving a request for authorization to establish a session of a service with a mobile device, wherein establishment of the session with the mobile device requires service provisioning; and (2) a second executable portion for automatically provisioning the service for the mobile device in response to receipt of the request.

According to another aspect of the present invention, a mobile device is provided, wherein the mobile device comprises a processor and a memory in communication with the processor. In one exemplary embodiment, the memory stores an application executable by the processor, wherein the application is capable, upon execution, of: (1) receiving a notification of a requested session establishment, said notification requesting that said mobile device authorize provisioning of a service needed for the session establishment; and (2) authorizing provisioning of the service.

In one exemplary embodiment, the application may further be capable, upon execution, of receiving, in response to authorizing provisioning of the service, one or more settings necessary for implementing the service. In another exemplary embodiment, the application may further be capable, upon execution, of denying authorization to provisioning of the service.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as a provisioning system and/or service center in accordance with exemplary embodiments of the present invention;

FIG. 3 is a schematic block diagram of a mobile station capable of operating in accordance with an exemplary embodiment of the present invention;

FIG. 4 is a schematic block diagram of a system in which a Multimedia Messaging Service is capable of being provisioned in accordance with exemplary embodiments of the present invention; and

FIG. 5 is a flow chart illustrating the steps which may be taken in order to automatically provision a service in accordance with an exemplary embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a method, system, network entity and computer program product for automatically provisioning a service in the instance where a need for provisioning of the service arises. In particular, according to exemplary embodiments of the present invention, a provisioning system is configured to automatically provision a service for a mobile device as a result of there being a current desire or need to establish a session of the service with the mobile device. In one exemplary embodiment, this may occur where a third party wishes to conduct a video call with the user of the mobile device, wherein conducting the call requires that a video call service be provisioned to the mobile device. In another exemplary embodiment, a messaging service may be provisioned for a mobile device as a result of the mobile device becoming the intended recipient of a message that requires such service provisioning. As used herein, therefore, a “session” of a service may refer to any instance of a service requiring service provisioning (e.g., any non-connection oriented service) including, for example, transmittal of an MMS, or other similar, message, transmittal of an email, participation in a video call or video instant messaging conversation, or the like. Provisioning the service may involve arranging for various settings needed to implement the service to be transmitted to the mobile device, as well as updating the mobile device's subscription information to include the subscriptions needed for the particular messaging service.

Exemplary embodiments of the present invention, therefore, overcome the aforementioned drawbacks to the known prior art methods of fulfilling the latter two requirements for establishing sessions of a service (e.g., receiving MMS, and similar, messages). In particular, exemplary embodiments eliminate the need for a user to manually request the requisite settings and subscriptions, while not requiring that the network operator unnecessarily invest in hardware, bandwidth and/or product licenses in order to provision the service to all of its subscribers. According to exemplary embodiments, the network operator is capable of automatically providing a user with the services he or she needs only in the instance where he or she actually needs them; thus improving the position of both the subscriber and the network operator by alleviating the burden placed on each.

Overall System and Mobile Device:

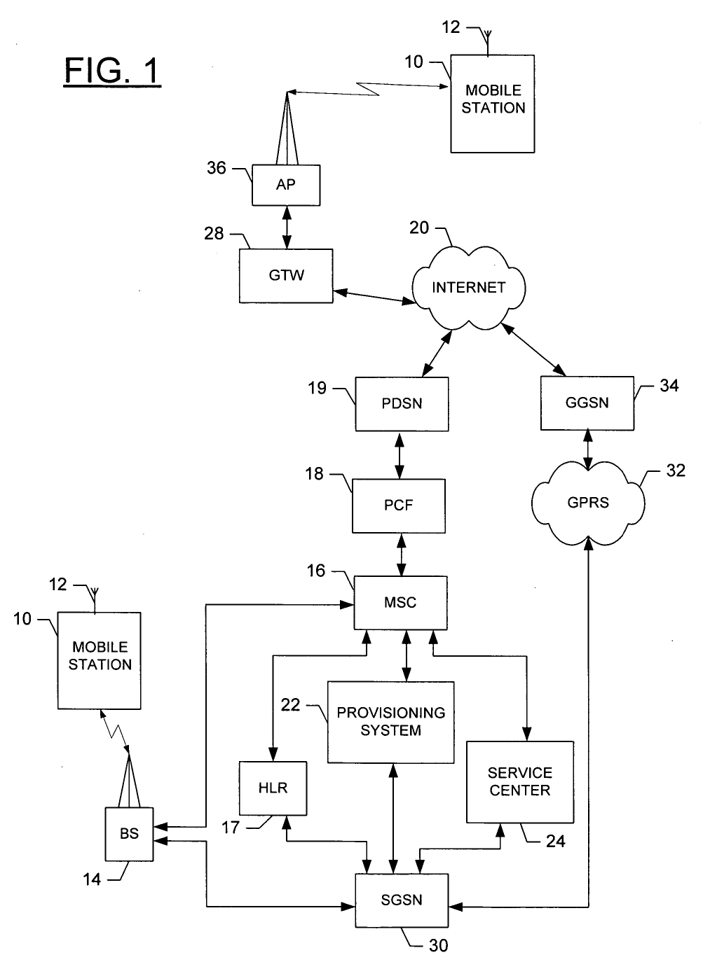

Referring to FIG. 1, an illustration of one type of system that would benefit from the present invention is provided. As shown in FIG. 1, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

In one exemplary embodiment, the MSC 16 is connected to a provisioning system 22, and a service center 24, for the purpose of providing any number of services to mobile subscribers (discussed in further detail below). In addition, the MSC 16 may connect to a home location register (HLR) 17 for the purpose of determining where various mobile subscribers are located within the network. The HLR 17 is a central database storing information regarding all subscribers within a service provider's home service area. In particular, the HLR 17 stores details of every Subscriber Identity Module (SIM) card issued by a mobile phone operator, wherein each SIM card has as unique identifier referred to as an International Mobile Subscriber Identity (IMSI).

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20, as well as to the HLR 17, provisioning system 22 and service center 24. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to one or more processing elements across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

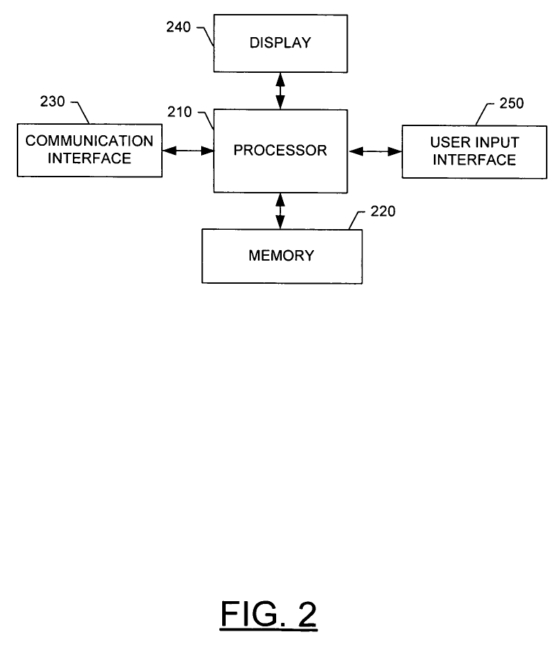

Referring now to FIG. 2, a block diagram of an entity capable of operating as a Provisioning System 22 and/or Service Center 24 is shown in accordance with one embodiment of the present invention. The entity capable of operating as a Provisioning System 22 and/or Service Center 24 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a Provisioning System 22 and/or Service Center 24 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

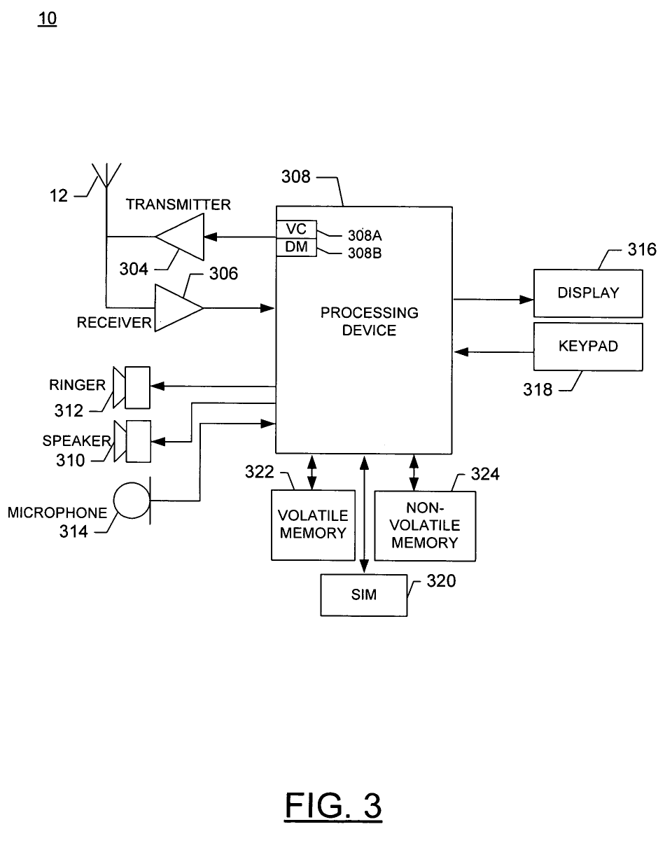

Reference is now made to FIG. 3, which illustrates one type of mobile device or station 10 that would benefit from embodiments of the present invention. It should be understood, however, that the mobile device or station illustrated and hereinafter described is merely illustrative of one type of mobile device that would benefit from the present invention and, therefore, should not be taken to limit the scope of the present invention. Other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 12, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means for receiving various configuration settings from the network using an Over-the-Air (OTA) protocol (discussed in further detail below). The mobile station may further comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for receiving a notification of a requested session establishment (e.g., notification that an MMS message has been sent to the mobile device), wherein the notification includes a request that the mobile device authorize provisioning of a service needed for the requested session establishment (e.g., authorization to provision MMS), and computer program code for authorizing provisioning of the service.

The system, method, network entity and computer program product of exemplary embodiments of the present invention are primarily described in conjunction with mobile communications applications. It should be understood, however, that the system, method, network entity and computer program product of embodiments of the present invention can be utilized in conjunction with a variety of other applications, both in the mobile communications industries and outside of the mobile communications industries. For example, the system, method, network entity and computer program product of exemplary embodiments of the present invention can be utilized in conjunction with wireline and/or wireless network (e.g., Internet) applications.

Method of Automatic Service Provisioning:

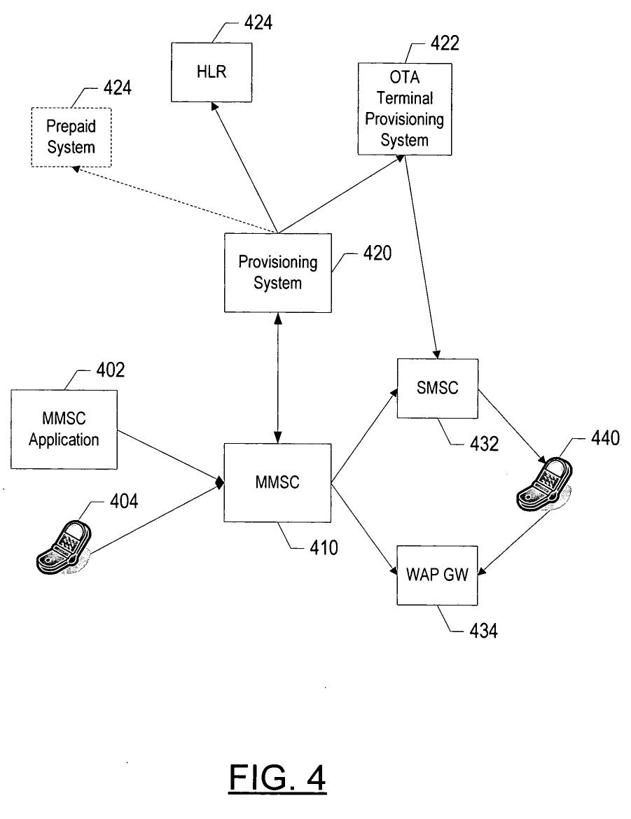

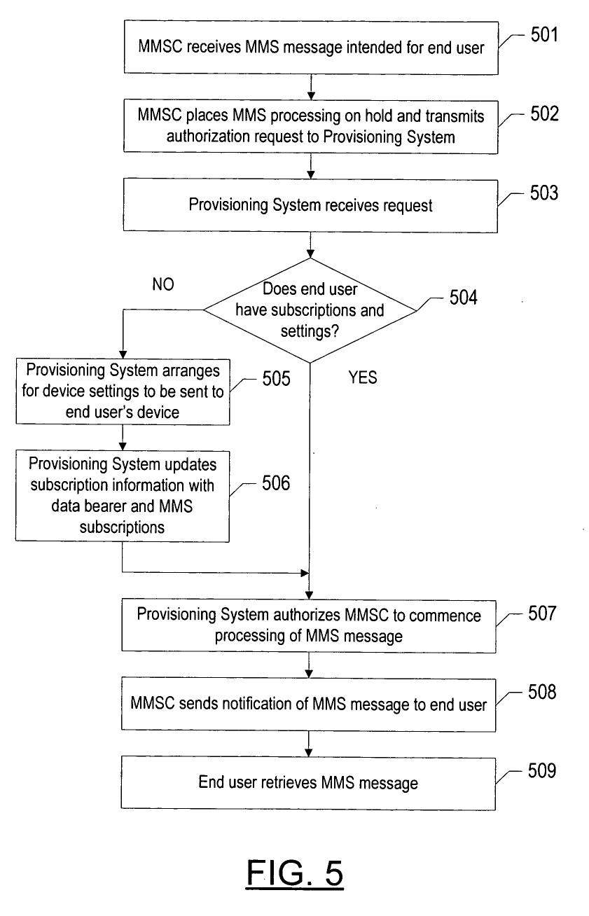

Reference is now made to FIGS. 4 and 5, which illustrate in more detail a system and method for automatically provisioning a Multimedia Messaging Service (MMS) in accordance with exemplary embodiments of the present invention. As one of ordinary skill in the art will recognize, however, reference is made to MMS for exemplary purposes only and should not be taken to limit the scope of the invention to provisioning of MMS. As noted above, the method, system, network entity and computer program product of exemplary embodiments of the present invention are capable of provisioning other types of messaging or similar non-connection-oriented services that likewise require that the intended recipient have certain subscription information and/or settings.

As shown, the method begins when, in Step 501, a service center, such as a Multimedia Messaging Service Center 410 (MMSC), receives an MMS message that is intended for the end user 440. The MMS message may have originated from another individual's communications device 404 (i.e., a person-to-person MMS transmission), or from an MMS application 402 from which the end user has requested transmission of an MMS message.

Upon receipt of the MMS message, the MMSC 410, in Step 502, places the MMS transaction processing on hold and transmits a request to a provisioning system 420 for authorization to transmit the MMS message to the end user 440. The authorization request should include information to identify the intended recipient 440, such as the Mobile Subscriber Integrated Services Digital Network (ISDN) Number (MSISDN) and/or International Mobile Subscriber Identity (IMSI) of the end user device 440.

Step 502 may be done, for example, using a real-time charging interface, such as Nokia's In-Advance Credit Check (IACC), which is ordinarily used in conjunction with a Pre-Paid System 424 to place the MMS transaction processing on hold while it is determined whether or not the intended recipient 440 has sufficient funds to pay for the MMS message. In that scenario, only after it is determined that the intended recipient 440 has sufficient funds would notification of the MMS message be sent. While not shown in FIG. 5, this pre-paid authorization step may also be performed, for example, prior to requesting authorization in Step 502. Alternatively, the sender in a person-to-person transmission may take responsibility for paying the fee for transmitting the MMS message, or the fee may be waived altogether, for example where the service provider is attempting to attract new subscribers.

The provisioning system 420 can be any system capable of performing all types of provisioning within a network (e.g., capable of placing subscriber information in a database, discussed in further detail below). While shown as separate entities, as one of ordinary skill in the art will recognize, the functions described herein as being performed by the MMSC 410 and the provisioning system 420, respectively, are likewise capable of being performed by a single entity operating in both capacities.

In Step 503, the provisioning system 420 receives the authorization request, for example, via a northbound interface capable of receiving requests using an Application Program Interface (API) provided by the MMSC 410. Upon receipt, the provisioning system 420 determines what actions must be performed in order for the intended recipient or end user 440 to receive the MMS message. In particular, the provisioning system 420, in Step 504, determines whether the intended recipient 440 has the subscriptions (i.e., whether the device is registered to receive the service) and settings (i.e., whether the device is configured to receive the service) necessary for receipt of the MMS message. In one exemplary embodiment, determining which actions need to be taken may further include verifying that the end user device 440 has sufficient capabilities to support MMS messaging.

In one exemplary embodiment, in order to determine what actions need to be taken, the provisioning system 420 may access a database maintained by the provisioning system 420 that includes information on all subscribers previously provisioned by the provisioning system 420. Alternatively, the provisioning system 420 may access a database or directory maintained by the end user's network operator or service provider that includes information, such as subscription and device capability information, for all subscribers.

If the intended recipient 440 already has the needed settings and subscriptions (i.e., the service has already been provisioned), the provisioning system 420 will transmit a response to the MMSC 410 instructing the MMSC 410 to go ahead and notify the end user 440 of the incoming MMS message (Step 507).

If, however, it is determined that the intended recipient 440 does not have the requisite settings and/or subscriptions (i.e., the service has not already been provisioned), the provisioning system, in Step 505, arranges for the device settings needed for receipt of an MMS message to be sent to the end user 440. This may occur, for example, where the service has never before been provisioned to the end user. Alternatively, in another exemplary embodiment, it may occur where, for example, while the service has already been provisioned to the end user and, in particular, the settings have already been transmitted to the end user, for some reason the transfer of an MMS is not working. In this case the end user might have changed the settings manually, or something else may be wrong in the device. In this case, it may be beneficial to re-provision the service to the device and, in particular, retransmit the settings to the device.

In one exemplary embodiment, the provisioning system 420 arranges for the device settings to be sent to the end user 440 by transmitting a request to an Over-the-Air (OTA) Terminal provisioning system 422, which is capable of configuring a mobile device using an OTA protocol, requesting that the necessary device settings be sent to the end user device 440. In another exemplary embodiment, the provisioning system 420 may act as the OTA provisioning system 422. In this embodiment, arranging for the device settings to be sent, therefore, comprises the provisioning system 420, itself, transmitting the requisite settings to the mobile device 440 directly.

In either instance, the device settings transmitted may include information necessary for the mobile device to contact the network operator or MMS service provider. This may include, for example, URI/URL (Universal Resource Identifier/Uniform Resource Locator), WAP gateway (GW), APN and/or IP addresses of the service provider or network operator.

In one exemplary embodiment, the OTA Terminal provisioning system 422 (whether standalone or operating as part of the overall provisioning system 420) may communicate settings to the device via, for example, a Short Message Service (SMS) text message, including instructions for the usage and purpose of the settings. As shown in FIG. 4, in this exemplary embodiment, the SMS message may be communicated to the end user device 440 by way of an SMS Center (SMSC) 432.

Following the provision of the requisite device settings, in Step 506, the provisioning system 420 then updates subscription information associated with the end user device 440 to include one or more subscriptions necessary to receive the MMS message. In particular, the provisioning system 420 may provide a subscription for the data bearer for MMS service (e.g., GPRS/3G) in a register, such as the Home Location Register (HLR) 424. In other words, the provisioning system 420 may update the end user's information in the HLR 424 to include a subscription for the data bearer for the MMS service.

The provisioning system 420 may further provide a subscription for the MMS service itself in the appropriate register. For example, the MMS subscription may be maintained by the MMSC 410; in which case, the provisioning system may provide the subscription information to the MMSC 410. In many instances, however, either an MMSC subscription is not necessary, or it has been provided to every subscriber having an MMS-capable device.

While not shown, in one exemplary embodiment, prior to performing the above provisioning steps (i.e., Steps 505 and 506), the provisioning system 420 may transmit a notification to the mobile device indicating that an MMS message is intended for the mobile device, and requesting authorization from the mobile device to provision the requisite service. In this exemplary embodiment, the provisioning system 420 would only perform Steps 505 and 506 after the mobile device has given its permission.

In addition, while the above describes the provisioning system 420 as performing both the step of arranging for the appropriate device settings to be sent to the end user device 440 (Step 505) and of updating subscription information associated with the end user 440 (Step 506), both steps may not be required in all instances. As one of ordinary skill in the art will recognize, in some instances, only one of the steps may be required. For example, the mobile device 440 may be configured to implement MMS, but not registered to do so, or vice versa.

Regardless of whether one or both of the preceding steps are required, once the MMS has been provisioned, the provisioning system 420 sends a message to the MMSC 410 authorizing the MMSC 410 to transmit the MMS message to the end user 440 (Step 507). In response, the MMSC 410, in Step 508, sends a notification to the end user that he or she has received an MMS message. As shown in FIG. 4, in one exemplary embodiment, the notification may be in the form of an SMS message sent via an SMSC 432.

Upon receipt of the notification, the end user, in Step 509, retrieves the MMS message from MMSC 410 via a Wireless Application Protocol (WAP) Gateway (GW) 434. As discussed above, delivery may be immediate (i.e., end user 440 receives MMS message immediately following notification, without any user intervention or knowledge) or deferred (i.e., recipient allowed to choose whether or not he or she desires to receive the MMS message).

Following the steps described above, the end user 440 now has the appropriate settings and subscriptions for receipt of subsequent MMS messages. While not shown, an additional step following retrieval of the MMS message, could be to remove end user's subscription in the HLR and/or change the settings of the end user device back to their original state. In other words, the method may include returning the end user back to the position he or she was in prior to becoming the intended recipient of an MMS, or other similar, message. The foregoing process would, therefore, likely be repeated where the end user 440 again becomes the intended recipient of an MMS, or other similar, message.

Conclusion:

As described above and as will be appreciated by one skilled in the art, embodiments of the present invention may be configured as a system, method or network entity. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of automatically provisioning a service, said method comprising:
receiving a request for authorization to establish a session of a service with a mobile device, wherein establishment of the session with the mobile device requires service provisioning; and
automatically provisioning the service for the mobile device in response to receipt of the request.

2. The method of claim 1, wherein provisioning the service comprises arranging for one or more settings necessary for implementing the service to be transmitted to the mobile device.

3. The method of claim 1, wherein provisioning the service comprises updating subscription information associated with the mobile device to include one or more subscriptions necessary for the service.

4. The method of claim 3, wherein the subscription information is maintained in a register associated with an operator responsible for providing one or more services to the mobile device.

5. The method of claim 1 further comprising:
determining whether the service was previously provisioned for the mobile device, wherein the step of automatically provisioning the service is only performed upon a determination that the service was not previously provisioned.

6. The method of claim 1 further comprising:
determining whether the mobile device is capable of supporting the service, wherein the step of automatically provisioning the service is only performed upon a determination that the mobile device is capable of supporting the service.

7. The method of claim 1, wherein establishing a session of a service with the mobile device comprises transmitting a message to the mobile device.

8. The method of claim 7, wherein the service comprises Multimedia Messaging Service (MMS), and wherein the message comprises an MMS message.

9. The method of claim 1 further comprising:
transmitting authorization to establish the session with the mobile device following provisioning of the service.

10. A network entity capable of automatically provisioning a service, said network entity comprising:
a processor; and
a memory in communication with the processor, said memory storing an application executable by the processor, wherein the application is capable, upon execution, of receiving a request for authorization to establish a session of a service with a mobile device, wherein establishment of the session with the mobile device requires service provisioning, and automatically provisioning the service for the mobile device in response to receipt of the request.

11. The network entity of claim 10, wherein provisioning the service comprises arranging for one or more settings necessary for implementing the service to be transmitted to the mobile device.

12. The network entity of claim 10, wherein provisioning the service comprises updating subscription information associated with the mobile device to include one or more subscriptions necessary for the service.

13. The network entity of claim 12, wherein the subscription information is maintained in a register associated with an operator responsible for providing one or more services to the mobile device.

14. The network entity of claim 10, wherein the application is further capable, upon execution, of determining whether the service was previously provisioned for the mobile device, and wherein the step of automatically provisioning the service is only performed upon a determination that the service was not previously provisioned.

15. The network entity of claim 10, wherein the application is further capable, upon execution, of determining whether the mobile device is capable of supporting the service, and wherein the step of automatically provisioning the service is only performed upon a determination that the mobile device is capable of supporting the service.

16. The network entity of claim 10, wherein establishing a session of a service comprises transmitting a message to the mobile device.

17. The network entity of claim 16, wherein the service comprises Multimedia Messaging Service (MMS), and wherein the message comprises an MMS message.

18. The network entity of claim 10, wherein the application is further capable, upon execution, of transmitting authorization to establish the session with the mobile device following provisioning of the service.

19. A system for automatically provisioning a service, said system comprising:
a mobile device;
a service center configured to receive a request to establish a session of a service with the mobile device, and, in response, to transmit a request for authorization to establish the session of the service with the mobile device, wherein establishment of the session with the mobile device requires service provisioning; and
a network entity configured to receive the request and to automatically provision the service for the mobile device in response to receipt of the request.

20. The system of claim 19, wherein provisioning the service comprises arranging for one or more settings necessary for implementing the service to be transmitted to the mobile device.

21. The system of claim 20 further comprising:
an Over-the-Air (OTA) Terminal provisioning system in communication with the network entity, wherein arranging for one or more settings necessary for implementing the service to be transmitted to the mobile device comprises transmitting a request to the OTA Terminal provisioning system requesting that said settings be transmitted.

22. The system of claim 19, wherein provisioning the service comprises updating subscription information associated with the mobile device to include one or more subscriptions necessary for the service.

23. The system of claim 22 further comprising:
a register associated with a network operator responsible for providing one or more services for the mobile device, wherein updating subscription information comprises updating subscription information maintained in the register.

24. The system of claim 23, wherein the register comprises a Home Location Register.

25. The system of claim 19, wherein receiving a request to establish a session of a service with the mobile device comprises receiving one or more messages destined for the mobile device, and wherein transmitting a request for authorization to establish the session of the service with the mobile device comprises transmitting a request for authorization to transmit the one or more messages to the mobile device.

26. The system of claim 25, wherein the service comprises Multimedia Messaging Service (MMS), and wherein the service center comprises a Multimedia Messaging Service Center (MMSC).

27. The system of claim 19, wherein the network entity is further configured to determine whether the service was previously provisioned for the mobile device, and to provision the service only upon a determination that the service was not previously provisioned.

28. The system of claim 19, wherein the network entity is further configured to determine whether the mobile device is capable of supporting the service, and to provision the service only upon a determination that the mobile device is capable of supporting the service.

29. The system of claim 19, wherein the network entity is further configured to transmit to the service center an authorization to establish the session with the mobile device following provisioning of the service.

30. The system of claim 29, wherein the service center is further configured to receive the authorization and, in response, to establish the session with the mobile device.

31. A computer program product for automatically provisioning a service, wherein the computer program product comprises at least one computer-readable storage medium having computer-readable program code portions stored therein, the computer-readable program code portions comprising:
a first executable portion for receiving a request for authorization to establish a session with a mobile device, wherein establishment of the session with the mobile device requires service provisioning; and
a second executable portion for automatically provisioning the service for the mobile device in response to receipt of the request.

32. The computer program product of claim 31, wherein provisioning the service comprises arranging for one or more settings necessary for implementing the service to be transmitted to the mobile device.

33. The computer program product of claim 31, wherein provisioning the service comprises updating subscription information associated with the mobile device to include one or more subscriptions necessary for the service.

34. The computer program product of claim 33, wherein the subscription information is maintained in a register associated with an operator responsible for providing one or more services to the mobile device.

35. The computer program product of claim 31 further comprising:
a third executable portion for determining whether the service was previously provisioned for the mobile device, wherein the second executable portion is configured to provision the service only upon a determination that the service was not previously provisioned.

36. The computer program product of claim 31 further comprising:
a third executable portion for determining whether the mobile device is capable of supporting the service, wherein the second executable portion is configured to provision the service only upon a determination that the mobile device is capable of supporting the service.

37. The computer program product of claim 31, wherein establishing a session of a service with the mobile device comprises transmitting a message to the mobile device.

38. The computer program product of claim 37, wherein the service comprises Multimedia Messaging Service (MMS), and wherein the message comprises an MMS message.

39. The computer program product of claim 31 further comprising:
a third executable portion for transmitting authorization to transmit the message to the mobile device following provisioning of the service.

40. A mobile device comprising:
a processor; and
a memory in communication with the processor, said memory storing an application executable by the processor, wherein the application is capable, upon execution, of:
receiving a notification of a requested session establishment, said notification requesting that said mobile device authorize provisioning of a service needed for the requested session establishment; and
authorizing provisioning of the service.

41. The mobile device of claim 40, wherein the application is further capable, upon execution, of receiving, in response to authorizing provisioning of the service, one or more settings necessary for implementing the service.

42. The mobile of claim 40, wherein the application is further capable, upon execution, of denying authorization to provisioning of the service.

43. The mobile device of claim 40, wherein the requested session establishment comprises transmittal of a message intended for the mobile device.

44. The mobile device of claim 43, wherein the service comprises a Multimedia Messaging Service (MMS), and wherein the message comprises a MMS message.
